(19) United States
(12) Patent Application Publication
(10) Pub. No.: US 2018/0114052 A1
(43) Pub. Date: Apr. 26, 2018

(54) FINGERPRINT IDENTIFICATION MODULE

(71) Applicant: Primax Electronics Ltd., Taipei (TW)

(72) Inventors: MAO-HSIU HSU, Taipei (TW); KUAN-PAO TING, Taipei (TW)

(21) Appl. No.: 15/367,838

(22) Filed: Dec. 2, 2016

(30) Foreign Application Priority Data
Oct. 21, 2016 (TW) 105134115

(51) Int. Cl. G06K 9/00

(52) U.S. Cl. CPC G06K 9/00087; G06K 9/00053

(57) ABSTRACT

A fingerprint identification module includes a fingerprint sensor, a coating structure and a circuit board. The fingerprint sensor is disposed on the circuit board. The coating structure is disposed on the fingerprint sensor. An insulation layer of the coating structure is disposed on the top surface of the fingerprint sensor to isolate electrostatic charges from entering the fingerprint sensor. The coating structure of the fingerprint identification module of the present invention is used for isolating electrostatic charges in replace of the metallic ring of the conventional technology. Consequently, the material cost of the metallic ring is reduced, and the thickness of the fingerprint identification module is reduced.

### FIELD OF THE INVENTION

The present invention relates to an identity identification element, and more particularly to a fingerprint identification module for identifying the identity of a user through a fingerprint.

### BACKGROUND OF THE INVENTION

Recently, a fingerprint identification technology has been applied to a variety of electronic products. By using the fingerprint identification technology, the user's fingerprint can be inputted into an electronic product and saved in the electronic product. For unlocking the electronic product, the user has to input the fingerprint through a fingerprint identification module. The way of unlocking the electronic product by the fingerprint identification technology is faster and more user-friendly than the way of manually inputting the password. Consequently, the fingerprint identification technology is favored by many users, and the demands on the fingerprint identification module are gradually increased.

A structure of a conventional fingerprint identification module will be described as follows. FIG. 1 is a schematic exploded view illustrating a structure of a conventional fingerprint identification module. As shown in FIG. 1, the conventional fingerprint identification module 1 comprises a fingerprint sensor 10, a coating structure 11, a circuit board 12 and a metallic ring 13. The fingerprint sensor 10 is disposed on and electrically connected with the circuit board 12 and acquires electric power from the circuit board 12. The fingerprint sensor 10 is used for sensing the user's finger and retrieving the information of the user's finger. The coating structure 11 is disposed on a top surface of the fingerprint sensor 10 by a coating technology. The coating structure 11 is used for protecting the fingerprint sensor 10. Moreover, the coating structure 11 provides a color that matches an electronic device or provides a desired color. The metallic ring 13 is sheathed around the fingerprint sensor 10. The metallic ring 13 is used for transferring the charges of the user's finger or the foreign charges. Consequently, the electrostatic discharge (ESD) is not generated.

As mentioned above, the conventional fingerprint identification module 1 is equipped with the metallic ring 13 to avoid the generation of the electrostatic discharge. However, the use of the metallic ring 13 not only increases the material cost and the assembling cost but also increases the thickness of the fingerprint identification module 1.

Therefore, there is a need of providing a fingerprint identification module with a small thickness and capable of avoiding the electrostatic discharge.

### SUMMARY OF THE INVENTION

The present invention provides a fingerprint identification module with a small thickness and capable of avoiding the electrostatic discharge.

In accordance with an aspect of the present invention, there is provided a fingerprint identification module. The fingerprint identification module includes a fingerprint sensor, a coating structure and a circuit board. The fingerprint sensor detects a fingerprint image of a finger. The coating structure is disposed on a top surface of the fingerprint sensor, and includes an insulation layer and a protective layer. The insulation layer is disposed on the top surface of the fingerprint sensor to isolate electrostatic charges from entering the fingerprint sensor. The protective layer is disposed over the insulation layer to protect the insulation layer. The circuit board is located under the fingerprint sensor and electrically connected with the fingerprint sensor. A thickness of the insulation layer is in a range between 5 and 11 micrometers.

From the above descriptions, the present invention provides the fingerprint identification module. The coating structure of the fingerprint identification module is additionally equipped with the insulation layer to replace the metallic ring of the conventional technology. The insulation layer is used for isolating electrostatic charges. Since the thickness of the insulation layer is in the range between 5 and 11 micrometers, the thickness of the fingerprint identification module is not obviously increased. Moreover, since the fingerprint identification module is not equipped with the metallic ring, the material cost of the metallic ring is reduced and the thickness of the metallic ring is reduced. Since the thickness of the fingerprint identification module is reduced, the fingerprint identification module is slim.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a structure of a conventional fingerprint identification module;

FIG. 2 is a schematic exploded view illustrating a fingerprint identification module according to a first embodiment of the present invention;

FIG. 3 is a schematic perspective view illustrating the fingerprint identification module according to the first embodiment of the present invention and taken along a first viewpoint;

FIG. 4 is a schematic perspective view illustrating the fingerprint identification module according to the first embodiment of the present invention and taken along a second viewpoint;

FIG. 5 is a schematic cross-sectional view illustrating the coating structure of the fingerprint identification module according to the first embodiment of the present invention; and

FIG. 6 is a schematic perspective view illustrating a fingerprint identification module according to a second embodiment of the present invention.

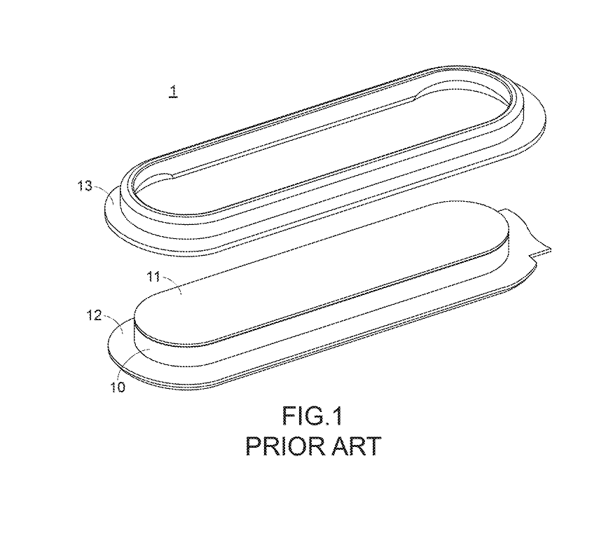

### DETAILED DESCRIPTION OF THE PREFERRED EMBODIMENT

For solving the drawbacks of the conventional technologies, the present invention provides a fingerprint identification module.

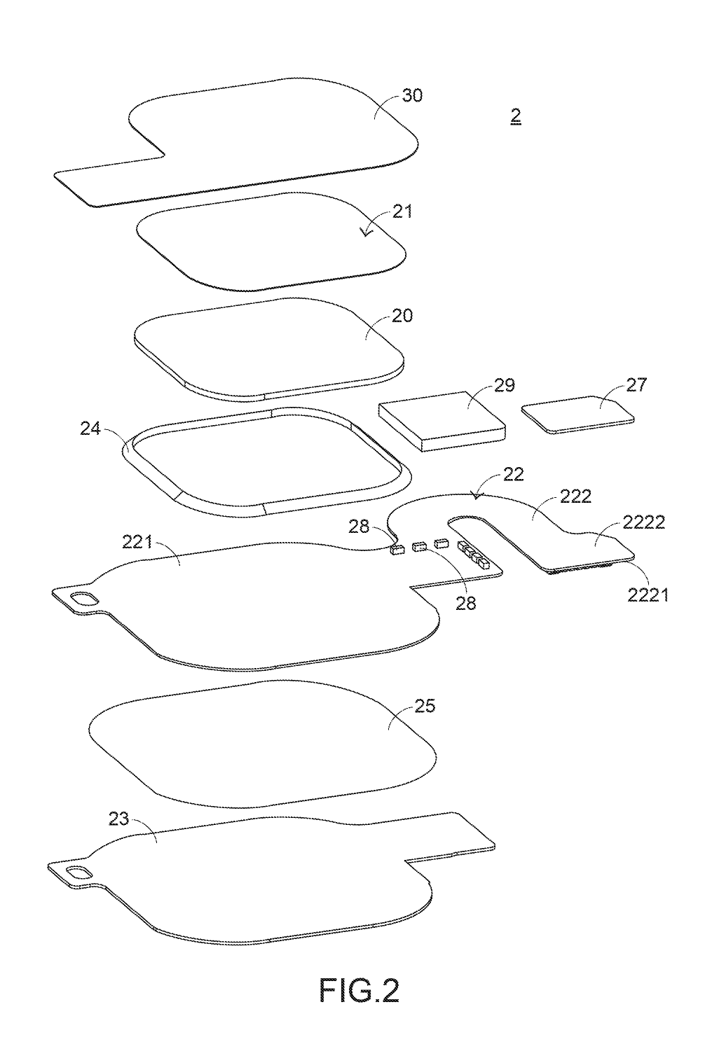

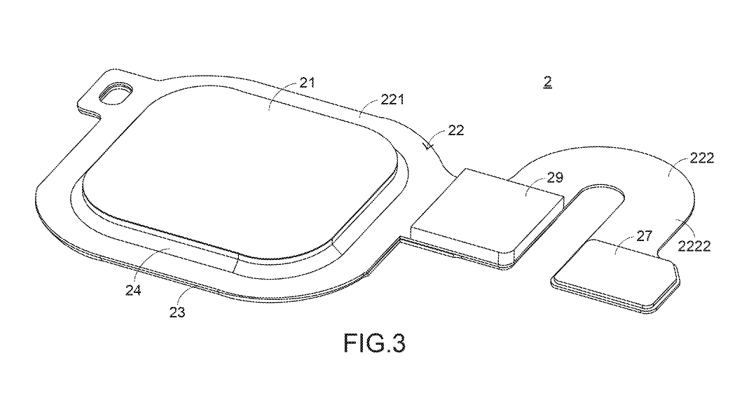

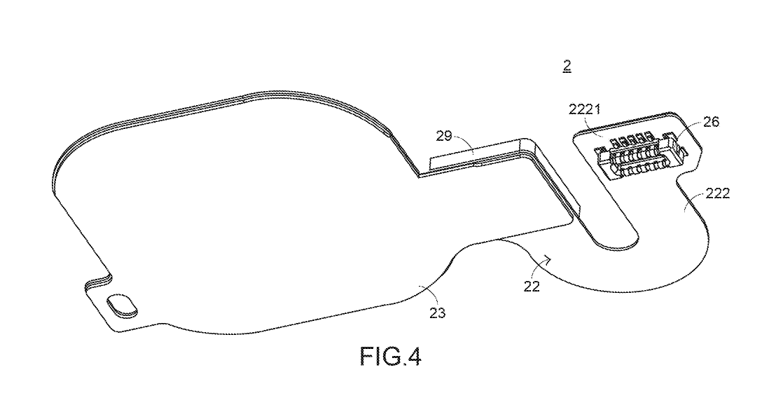

Please refer to FIGS. 2, 3 and 4. FIG. 2 is a schematic exploded view illustrating a fingerprint identification module according to a first embodiment of the present invention. FIG. 3 is a schematic perspective view illustrating the fingerprint identification module according to the first embodiment of the present invention and taken along a first viewpoint. FIG. 4 is a schematic perspective view illustrating the fingerprint identification module according to the first embodiment of the present invention and taken along a second viewpoint.

As shown in FIG. 2, the components of the fingerprint identification module 2 comprise a fingerprint sensor 20, a coating structure 21, a circuit board 22, a supporting plate 23, a first waterproof structure 24, an adhesive layer 25, a connector 26 (see FIG. 4), a wire supporting structure 27, plural electronic components 28 and a second waterproof structure 29. The fingerprint sensor 20 is used for detecting an image of a user's fingerprint (not shown). The coating structure 21 is disposed on a top surface of the fingerprint sensor 20 by a coating technology. The circuit board 22 is located under the fingerprint sensor 20 and electrically connected with the fingerprint sensor 20. The circuit board 22 provides electric power to the fingerprint sensor 20. Moreover, the circuit board 22 receives signals from the fingerprint sensor 20 and transmits the signals to other components. The circuit board 22 comprises a board body 221 and a wiring part 222. The electronic components 28 and the fingerprint sensor 20 are supported by the board body 221. The wiring part 222 is extended from the board body 221. The shape and the length of the wiring part 222 may be varied according to the practical requirements. The shape and the length of the wiring part 222 as shown in the drawings are presented herein for purpose of illustration and description only. In an embodiment, the fingerprint sensor 20 has a land grid array (LGA) package structure or a ball grid array (BGA) structure, and the circuit board 22 is a flexible printed circuit (FPC) or a rigid-flex board.

The supporting plate 23 is located under the circuit board 22 for increasing the structural strength of the circuit board 22. The first waterproof structure 24 is disposed on the circuit board 22 and arranged around the fingerprint sensor 20. By the first waterproof structure 24, the foreign liquid is prevented from entering the fingerprint sensor 20 through a space between the fingerprint sensor 20 and the circuit board 22. That is, the first waterproof structure 24 provides a waterproof function. The adhesive layer 25 is arranged between the supporting plate 23 and the circuit board 22. The supporting plate 23 and the circuit board 22 are combined together through the adhesive layer 25. In an embodiment, the first waterproof structure 24 is a waterproof sealant.

The connector 26 is disposed on a first surface 2221 of the wiring part 222. The electrical connection between the board body 221 of the circuit board 22 and an external electronic element (not shown) is established through the connector 26. For example, the external electronic element is a connection part of an electronic device where the fingerprint identification module 2 is installed. The wire supporting structure 27 is disposed on a second surface 2222 of the wiring part 222. That is, the wire supporting structure 27 is disposed on an opposite side of the connector 26. The wire supporting structure 27 is used for increasing the structural strength of the wiring part 222. Consequently, the connector 26 can be securely fixed on the wiring part 222. The plural electronic components 28 are disposed on the board body 221 of the circuit board 22 for providing special functions. The second waterproof structure 29 is disposed on the board body 221 of the circuit board 22 to cover the plural electronic components 28. By the second waterproof structure 29, the foreign liquid is prevented from entering the plural electronic components 28. After the above components are combined together, the fingerprint identification module 2 is assembled. The resulting structure of the fingerprint identification module 2 is shown in FIGS. 3 and 4. In an embodiment, the plural electronic components 28 comprise capacitors, diodes or processors. Preferably but not exclusively, the second waterproof structure 29 is a waterproof sealant.

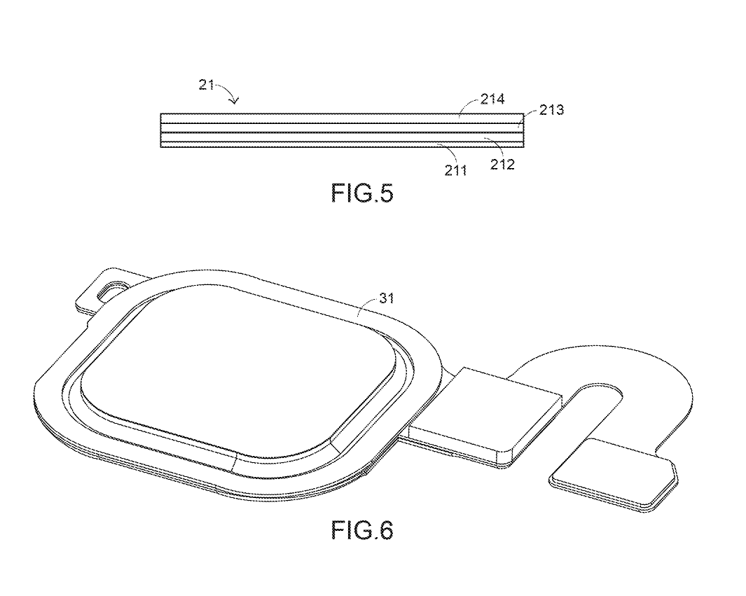

The structure of the coating structure 21 will be described in more detail as follows. FIG. 5 is a schematic cross-sectional view illustrating the coating structure of the fingerprint identification module according to the first embodiment of the present invention. As shown in FIG. 5, the coating structure 21 comprises an insulation layer 211, a primer layer 212, a color layer 213 and a protective layer 214. The insulation layer 211 is coated on a top surface of the fingerprint sensor 20. The insulation layer 211 is used for preventing the electrostatic charges from entering the fingerprint sensor 20. In an embodiment, the thickness of the insulation layer 211 is in the range between 5 and 11 micrometers. The primer layer 212 is coated on a top surface of the insulation layer 211 and used as a preliminary coat of paint. The color layer 213 is coated on a top surface of the primer layer 212. The color layer 213 is made of color paint in order to express the desired color of the coating structure 21. In an embodiment, the insulation layer 211 is made of insulation resin, and the protective layer 214 is made of UV paint. Moreover, the insulation layer 211, the primer layer 212, the color layer 213 and the protective layer 214 are formed by a coating process.

The following three aspects should be specially described. Firstly, the coating structure 21 is additionally equipped with the insulation layer 211 under the primer layer 212, the color layer 213 and the protective layer 214. The insulation layer 211 is used for isolating electrostatic charges and preventing from the electrostatic discharge. If the thickness of the insulation layer 211 is too large, the fingerprint sensor 20 is adversely affected and the sensing sensitivity of the fingerprint sensor 20 is reduced. Whereas, if the thickness of the insulation layer 211 is too small, the efficacy of the insulation layer 211 to isolate the electrostatic charges is insufficient. The results of experiments demonstrate that the insulation layer 211 with the thickness in the range between 5 and 11 micrometers can achieve the function of providing desired sensing sensitivity of the fingerprint sensor 20 and the function of isolating electrostatic charges.

Secondly, after the fingerprint identification module 2 is assembled, a protecting film 30 is optionally disposed on a top surface of the coating structure 21 to protect the fingerprint identification module 2. The protecting film 30 provides temporary protection. Before the fingerprint identification module 2 is installed in the electronic device, the protecting film 30 has to be removed. Consequently, the fingerprint sensor 20 can be normally operated.

Thirdly, the results of experiments demonstrate that the electronic device with the fingerprint identification module 2 can pass the contact discharge test of an electrostatic plasma gun at the voltage levels of −4 kilovolts˜+4 kilovolts, −6 kilovolts˜+6 kilovolts and −8 kilovolts˜+8 kilovolts sequentially. Moreover, the electronic device with the fingerprint identification module 2 can pass the non-contact discharge test of an electrostatic plasma gun at the voltage levels of −8 kilovolts˜+8 kilovolts, −10 kilovolts˜+10 kilovolts, −12 kilovolts˜+12 kilovolts and −15 kilovolts˜+15 kilovolts sequentially. In other words, the fingerprint identification module can pass the high-standard electrostatic discharge test.

The present invention further provides a second embodiment. FIG. 6 is a schematic perspective view illustrating a fingerprint identification module according to a second embodiment of the present invention. In this embodiment, the fingerprint identification module further comprises a foam structure 31. The foam structure 31 is disposed on the circuit board and arranged around the first waterproof structure. When the fingerprint identification module is installed in an electronic device, the foam structure 31 can absorb vibration impact. In other words, the foam structure 31 can provide an anti-vibration function. It is noted that numerous modifications and alterations may be made while retaining the teachings of the invention. For example, in another embodiment, the foam structure is located under the supporting plate for providing the anti-vibration function.

From the above descriptions, the present invention provides the fingerprint identification module. The coating structure of the fingerprint identification module is additionally equipped with the insulation layer to replace the metallic ring of the conventional technology. The insulation layer is used for isolating electrostatic charges. Since the thickness of the insulation layer is in the range between 5 and 11 micrometers, the thickness of the fingerprint identification module is not obviously increased. Moreover, since the fingerprint identification module is not equipped with the metallic ring, the material cost of the metallic ring is reduced and the thickness of the metallic ring is reduced. Since the thickness of the fingerprint identification module is reduced, the fingerprint identification module is slim.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A fingerprint identification module, comprising:
a fingerprint sensor detecting a fingerprint image of a finger;
a coating structure disposed on a top surface of the fingerprint sensor, and comprising an insulation layer and a protective layer, wherein the insulation layer is disposed on the top surface of the fingerprint sensor to isolate electrostatic charges from entering the fingerprint sensor, and the protective layer is disposed over the insulation layer to protect the insulation layer; and
a circuit board located under the fingerprint sensor and electrically connected with the fingerprint sensor,
wherein a thickness of the insulation layer is in a range between 5 and 11 micrometers.

2. The fingerprint identification module according to claim 1, wherein the coating structure further comprises:
a primer layer disposed on a top surface of the insulation layer; and
a color layer disposed on a top surface of the primer layer, wherein the coating structure expresses a color through the color layer.

3. The fingerprint identification module according to claim 2, wherein the insulation layer, the primer layer, the color layer and the protective layer are formed by a coating process.

4. The fingerprint identification module according to claim 1, further comprising:
a supporting plate located under the circuit board so as to increase a structural strength of the circuit board;
a waterproof structure disposed on the circuit board and arranged around the fingerprint sensor, wherein the first waterproof structure prevents foreign liquid from entering the fingerprint sensor; and
an adhesive layer arranged between the supporting plate and the circuit board, wherein the supporting plate and the circuit board are combined together through the adhesive layer.

5. The fingerprint identification module according to claim 4, wherein the circuit board comprises:
a board body, wherein an electronic component and the fingerprint sensor are supported by the board body; and
a wiring part extended from the board body.

6. The fingerprint identification module according to claim 5, further comprising:
a connector disposed on a first surface of the wiring part, wherein the board body of the circuit board and an external electronic element are electrically connected with each other through the connector;
a wire supporting structure disposed on a second surface of the wiring part so as to increase a structural strength of the wiring part;
the electronic component disposed on the board body of the circuit board; and
an additional waterproof structure disposed on the board body of the circuit board to cover the electronic component so as to prevent the foreign liquid from entering the electronic component.

7. The fingerprint identification module according to claim 1, wherein the insulation layer is made of insulation resin.

8. The fingerprint identification module according to claim 1, wherein the circuit board is a flexible printed circuit board.

9. The fingerprint identification module according to claim 1, further comprising a protecting film, wherein the protecting film is disposed on a top surface of the coating structure to protect the fingerprint identification module.

10. The fingerprint identification module according to claim 1, further comprising a foam structure, wherein the foam structure is disposed on the circuit board and arranged around the fingerprint sensor, or the foam structure is located under the circuit board, wherein the foam structure absorbs vibration impact.
